(19) United States
(12) Patent Application Publication
(10) Pub. No.: US 2022/0404262 A1
(43) Pub. Date: Dec. 22, 2022

(54) OPTICAL MEASUREMENT DEVICE AND LENS STRUCTURE

(71) Applicant: SONY GROUP CORPORATION, TOKYO (JP)

(72) Inventors: SATOSHI NAGAE, TOKYO (JP); KOJI KITA, KANAGAWA (JP); TAKASHI KATO, TOKYO (JP)

(21) Appl. No.: 17/755,387

(22) PCT Filed: Oct. 26, 2020
(86) PCT No.: PCT/JP2020/040090

§ 371 Date: Apr. 28, 2022

(30) Foreign Application Priority Data
Nov. 6, 2019 (JP) 2019-201745
Aug. 4, 2020 (JP) 2020-132111

(51) Int. Cl. G01N 15/14; G02B 7/02

(52) U.S. Cl. CPC G01N 15/1434; G02B 7/021; G01N 2015/1006

(57) ABSTRACT

Deterioration of optical characteristics is suppressed. An optical measurement device according to an embodiment includes: an excitation light source (101 to 103) that emits excitation light having a wavelength of at least 450 nanometers or less; a lens structure (116) that condenses the excitation light at a predetermined position; a fluorescence detection system (140) that detects fluorescence emitted from a particle by excitation of the particle present at the predetermined position by the excitation light; and a scattered light detection system (130) that detects scattered light generated by the excitation light being scattered by the particle present at the predetermined position, and the lens structure includes a plurality of lenses (21, 22, 23, 25, 26, 28) arranged along an optical axis of the excitation light and a lens frame (10) that holds the plurality of lenses, and a position of at least one of the plurality of lenses in the lens frame is determined by abutting on a lens adjacent to the lens.

### FIELD

The present disclosure relates to an optical measurement device and a lens structure.

### BACKGROUND

Conventionally, an optical measurement method using flow cytometry has been used for analysis of biologically relevant particles such as cells, microorganisms, and liposomes. The flow cytometer is a device for performing optical measurement using flow cytometry, in which particles flowing in a flow channel formed in a flow cell, a microchip, or the like are irradiated with light, and fluorescence or scattered light emitted from individual particles is detected, and analysis or the like is performed.

The flow cytometer includes an analyzer for the purpose of analyzing a sample, a sorter having a function of analyzing a sample and separating and collecting only particles having specific characteristics based on the analysis result, and the like. In addition, a sorter having a function of using a cell as a sample and separating and collecting the cell based on an analysis result is also called a “cell sorter”.

### CITATION LIST

### Patent Literature

Patent Literature 1: JP 2009-145213A

Patent Literature 2: JP 2012-127922A

### SUMMARY

### Technical Problem

In an optical measurement device for the purpose of fluorescence observation such as a flow cytometer, it is necessary to excite particles by irradiating the particles with a laser beam having a strong intensity, so that an objective lens for condensing the laser beam is required. An objective lens used in a general optical measurement device for the purpose of fluorescence observation or the like is a lens structure formed by combining a plurality of lenses, and an adhesive is used for assembly thereof. Therefore, there is a problem that the optical characteristics of the objective lens may be deteriorated due to burning of the adhesive caused by the laser light having a strong intensity, burning of outgas released from the adhesive and attached to a lens surface by excitation light, or the like.

Therefore, the present disclosure proposes an optical measurement device and a lens structure capable of suppressing deterioration of optical characteristics.

### Solution to Problem

To solve the above-described problem, an optical measurement device according to one aspect of the present disclosure comprises: an excitation light source that emits excitation light having a wavelength of at least 450 nanometers or less; a lens structure that condenses the excitation light at a predetermined position; a fluorescence detection system that detects fluorescence emitted from a particle by excitation of the particle present at the predetermined position by the excitation light; and a scattered light detection system that detects scattered light generated by the excitation light being scattered by the particle present at the predetermined position, wherein the lens structure includes a plurality of lenses arranged along an optical axis of the excitation light, and a lens frame that holds the plurality of lenses, and a position of at least one of the plurality of lenses in the lens frame is determined by abutting on a lens adjacent to the lens.

### BRIEF DESCRIPTION OF DRAWINGS

FIG. 1 is a schematic diagram illustrating a schematic configuration example of an optical system in a cell sorter according to an embodiment of the present disclosure.

FIG. 2 is a diagram illustrating an example of a reflecting surface of a perforated mirror according to an embodiment of the present disclosure.

FIG. 3 is a cross-sectional view illustrating dimensions when the perforated mirror according to an embodiment of the present disclosure is installed on an optical path of excitation light.

FIG. 4 is a diagram illustrating an example of light transmission characteristics of a dichroic mirror according to an embodiment of the present disclosure.

FIG. 5 is a diagram illustrating an example of an optical system from a spot in a microchip to a spectroscopic optical system according to an embodiment of the present disclosure.

FIG. 6 is a diagram illustrating an example of a beam diameter of fluorescent light in service at an incident end of a sorting fiber and a core diameter of the sorting fiber according to an embodiment of the present disclosure.

FIG. 7 is a diagram illustrating an example of a spectroscopic optical system according to an embodiment of the present disclosure.

FIG. 8 is a block diagram illustrating a schematic configuration example of an information processing system according to an embodiment of the present disclosure.

FIG. 9 is a schematic diagram illustrating a filter installed with respect to an optical axis of light traveling forward in a traveling direction of excitation light from a microparticle according to an embodiment of the present disclosure.

FIG. 10 is a diagram schematically illustrating a schematic configuration of a microchip according to an embodiment of the present disclosure.

FIG. 11 is a diagram for explaining a case where fluorescence and backscattered light according to a comparative example are not separated.

FIG. 12 is a diagram for explaining a case of separating fluorescence and backscattered light according to an embodiment of the present disclosure.

FIG. 13 is a cross-sectional view illustrating a schematic configuration example of an objective lens according to an embodiment of the present disclosure.

FIG. 14 is an optical path diagram illustrating a light beam of the objective lens illustrated in FIG. 13.

FIG. 15 is a cross-sectional view illustrating a schematic configuration example of an objective lens according to a modified example of an embodiment of the present disclosure.

FIG. 16 is an optical path diagram illustrating a light beam of the objective lens illustrated in FIG. 15.

FIG. 17 is a cross-sectional view illustrating a schematic configuration example of an objective lens according to a first specific example.

FIG. 18 is a cross-sectional view illustrating a schematic configuration example of an image forming lens according to an embodiment of the present disclosure.

FIG. 19 is a diagram illustrating an example of longitudinal aberration of an optical system in which the objective lens and the image forming lens according to the first specific example are combined (spherical aberration).

FIG. 20 is a diagram illustrating an example of longitudinal aberration of the optical system in which the objective lens and the image forming lens according to the first specific example are combined (astigmatism).

FIG. 21 is a diagram illustrating an example of longitudinal aberration of the optical system in which the objective lens and the image forming lens according to the first specific example are combined (distortion aberration).

FIG. 22 is a diagram illustrating an example of lateral aberration at an image height ratio of 1.0 of the optical system in which the objective lens and the image forming lens according to the first specific example are combined (tangential).

FIG. 23 is a diagram illustrating an example of lateral aberration at an image height ratio of 1.0 of the optical system in which the objective lens and the image forming lens according to the first specific example are combined (sagittal).

FIG. 24 is a diagram illustrating an example of a lateral aberration at an image height ratio of 0.5 of the optical system in which the objective lens and the image forming lens according to the first specific example are combined (tangential).

FIG. 25 is a diagram illustrating an example of lateral aberration at an image height ratio of 0.5 of the optical system in which the objective lens and the image forming lens according to the first specific example are combined (sagittal).

FIG. 26 is a cross-sectional view illustrating a schematic configuration example of an objective lens according to a second specific example.

FIG. 27 is a diagram illustrating an example of longitudinal aberration of an optical system in which the objective lens and an image forming lens according to the second specific example are combined (spherical aberration).

FIG. 28 is a diagram illustrating an example of longitudinal aberration of the optical system in which the objective lens and the image forming lens according to the second specific example are combined (astigmatism).

FIG. 29 is a diagram illustrating an example of longitudinal aberration of the optical system in which the objective lens and the image forming lens according to the second specific example are combined (distortion aberration).

FIG. 30 is a diagram illustrating an example of lateral aberration at an image height ratio of 1.0 of the optical system in which the objective lens and the image forming lens according to the second specific example are combined (tangential).

FIG. 31 is a diagram illustrating an example of lateral aberration at an image height ratio of 1.0 of the optical system in which the objective lens and the image forming lens according to the second specific example are combined (sagittal).

FIG. 32 is a diagram illustrating an example of lateral aberration at an image height ratio of 0.5 of the optical system in which the objective lens and the image forming lens according to the second specific example are combined (tangential).

FIG. 33 is a diagram illustrating an example of lateral aberration at an image height ratio of 0.5 of the optical system in which the objective lens and the image forming lens according to the second specific example are combined (sagittal).

FIG. 34 is a cross-sectional view illustrating a schematic configuration example of an objective lens according to a third specific example.

FIG. 35 is a diagram illustrating an example of longitudinal aberration of an optical system in which the objective lens and an image forming lens according to the third specific example are combined (spherical aberration).

FIG. 36 is a diagram illustrating an example of longitudinal aberration of the optical system in which the objective lens and the image forming lens according to the third specific example are combined (astigmatism).

FIG. 37 is a diagram illustrating an example of longitudinal aberration of the optical system in which the objective lens and the image forming lens according to the third specific example are combined (distortion aberration).

FIG. 38 is a diagram illustrating an example of lateral aberration at an image height ratio of 1.0 of the optical system in which the objective lens and the image forming lens according to the third specific example are combined (tangential).

FIG. 39 is a diagram illustrating an example of lateral aberration at an image height ratio of 1.0 of the optical system in which the objective lens and the image forming lens according to the third specific example are combined (sagittal).

FIG. 40 is a diagram illustrating an example of lateral aberration at an image height ratio of 0.5 of the optical system in which the objective lens and the image forming lens according to the third specific example are combined (tangential).

FIG. 41 is a diagram illustrating an example of lateral aberration at an image height ratio of 0.5 of the optical system in which the objective lens and the image forming lens according to the third specific example are combined (sagittal).

### DESCRIPTION OF EMBODIMENTS

Hereinafter, embodiments of the present disclosure will be described in detail with reference to the drawings. Note that, in each of the following embodiments, the same parts are denoted by the same reference signs, and redundant description will be omitted.

The present disclosure will be described according to the following order of items shown below.

1. Overall configuration of device

1.1 Schematic configuration example of optical system

1.2 Schematic configuration example of information processing system

1.3 Timing control example using forward scattered light

1.4 Alignment

2. Schematic configuration of microchip

3. Effect of separating fluorescence and backscattered light using dichroic mirror

4. Objective lens

4.1 Schematic configuration example of objective lens

4.1.1 Optical system

4.1.1.1 Modified example of optical system

4.1.2 Lens barrel system

4.2 Effect of structure not using adhesive

5. Specific example of objective lens

5.1 First specific example

5.2 Second specific example

5.3 Third specific example

1. Overall Configuration of Device

First, an overall configuration of an optical measurement device according to the present embodiment will be described in detail with reference to the drawings. Note that, in the present embodiment, a cell analyzer is exemplified as the optical measurement device. The cell analyzer according to the present embodiment may be, for example, a cell sorter type flow cytometer (hereinafter, simply referred to as a cell sorter).

Furthermore, in the present embodiment, a microchip method is exemplified as a method of supplying microparticles to an observation point (hereinafter, referred to as a spot) on a flow path, but the present disclosure is not limited thereto, and for example, various methods such as a droplet method, a cuvette method, and a flow cell method can be adopted. Furthermore, the technique according to the present disclosure is not limited to the cell sorter, and can be applied to various optical measurement devices that measure microparticles passing through a spot set on a flow path, such as an analyzer-type flow cytometer or a microscope that acquires an image of the microparticles on the flow path.

1.1 Schematic Configuration Example of Optical System

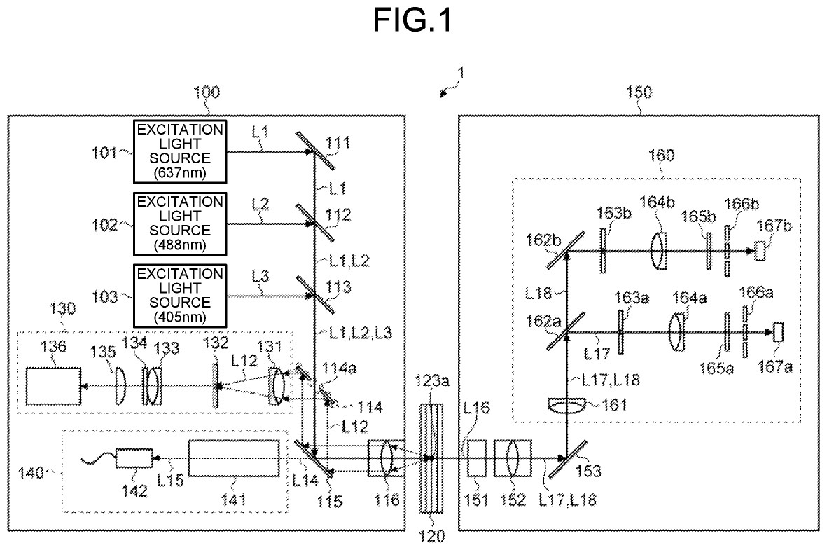

FIG. 1 is a schematic diagram illustrating a schematic cfiguration example of an optical system in a cell analyzer according to the present embodiment. As illustrated in FIG. 1, a cell analyzer 1 includes, for example, one or more (three in this example) excitation light sources 101 to 103, a total reflection mirror 111, dichroic mirrors 112 and 113, a perforated mirror 114, a dichroic mirror 115, an objective lens 116, a microchip 120, a backscattered light detection system 130, a fluorescence detection system 140, a filter 151, a collimating lens 152, a total reflection mirror 153, and a forward scattered light detection system 160.

In this configuration, the total reflection mirror 111, the dichroic mirrors 112 and 113, the perforated mirror 114, and the dichroic mirror 115 constitute a waveguide optical system that guides excitation light L1, excitation light L2, and excitation light L3 emitted from the excitation light sources 101 to 103 to a predetermined optical path. Among them, the dichroic mirror 115 forms a separation optical system that separates fluorescent light (for example, fluorescence L14) and scattered light (for example, backscattered light L12) out of light emitted in a predetermined direction (for example, rearward) from a spot 123a set on a flow path in the microchip 120. Further, the perforated mirror 114 constitutes a reflection optical system that reflects the scattered light (for example, the backscattered light L12) separated by the separation optical system to an optical path (for example, an optical path toward a backscattered light detection system 130 to be described later) different from the predetermined optical path.

Furthermore, the objective lens 116 constitutes a condensing optical system that condenses the excitation light L1, the excitation light L2 and the excitation light L3 propagated through the predetermined optical path on the spot 123a set on the flow path in the microchip 10. Note that the number of spots 123a is not limited to one, that is, the excitation light L1, the excitation light L2 and the excitation light L3 may be condensed on different spots, respectively. In addition, the condensing positions of the excitation light L1, the excitation light L2 and the excitation light L3 do not need to coincide with the spot 123a, and may be shifted.

In the example illustrated in FIG. 1, three excitation light sources 101 to 103 that emit the excitation light L1, the excitation light L2 and the excitation light L3 having different wavelengths are provided. For each of the excitation light sources 101 to 103, for example, a laser light source that emits coherent light may be used. For example, the excitation light source 102 may be a diode pumped solid state laser (DPSS laser) that emits a blue laser beam (peak wavelength: 488 nm (nanometer), power: 20 mW). Furthermore, the excitation light source 101 may be a laser diode that emits a red laser beam (peak wavelength: 637 nm, power: 20 mW), and similarly, the excitation light source 103 may be a laser diode that emits a near-ultraviolet laser beam (peak wavelength: 405 nm, power: 8 mW). In addition, the excitation light L1, the excitation light L2 and the excitation light L3 emitted from the excitation light sources 101 to 103, respectively, may be pulsed light.

The total reflection mirror 111 may be, for example, a total reflection mirror that reflects the excitation light L1 in a predetermined direction, which has been emitted from the excitation light source 101.

The dichroic mirror 112 is an optical element that makes an optical axis of the excitation light L1 reflected by the total reflection mirror 111 coincide with or parallel to an optical axis of the excitation light L2 emitted from the excitation light source 102. For example, the dichroic mirror transmits the excitation light L1 from the total reflection mirror 111 and reflects the excitation light L2 from the excitation light source 102. For example, a dichroic mirror designed to transmit light having a wavelength of 637 nm and reflect light having a wavelength of 488 nm may be used as the dichroic mirror 112.

The dichroic mirror 113 is an optical element for making the optical axes of the excitation light L1 and the excitation light L2 from the dichroic mirror 112 coincide with or parallel to an optical axis of the excitation light L3 emitted from the excitation light source 103. For example, the dichroic mirror transmits the excitation light L1 from the total reflection mirror 111 and reflects the excitation light L3 from the excitation light source 103. For example, a dichroic mirror designed to transmit light having a wavelength of 637 nm and light having a wavelength of 488 nm and reflect light having a wavelength of 405 nm may be used as the dichroic mirror 113.

The excitation light L1, the excitation light L2 and the excitation light L3 finally collected as light traveling in the same direction by the dichroic mirror 113 are incident on the dichroic mirror 115 through a hole 114a provided in the perforated mirror 114.

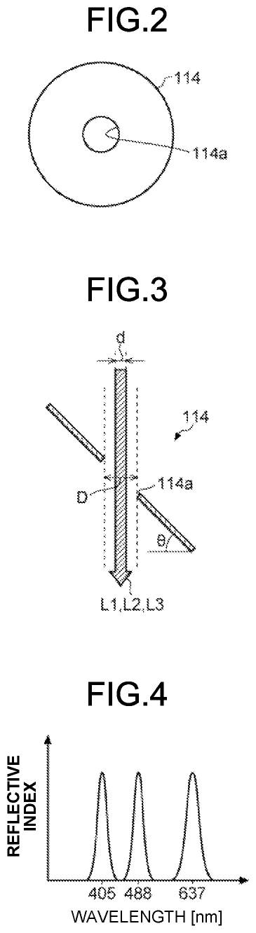

Here, the shape of the perforated mirror will be described with reference to FIGS. 2 and 3. FIG. 2 is a diagram illustrating an example of a reflecting surface of the perforated mirror according to the present embodiment, and FIG. 3 is a cross-sectional view illustrating dimensions when the perforated mirror according to the present embodiment is installed on an optical path of the excitation light.

As illustrated in FIG. 2, the perforated mirror 114 has, for example, a structure in which a hole 114a is provided substantially at a center of a circular reflecting surface. The reflecting surface of the perforated mirror 114 is designed to reflect at least light having a wavelength of 488 nm corresponding to the excitation light L2, for example.

As illustrated in FIG. 3, the perforated mirror 114 is disposed to be inclined at a predetermined angle (for example, 45 degrees) with respect to the optical axes of the excitation light L1, the excitation light L2 and the excitation light L3 in order to reflect at least a part of the backscattered light L12 from the spot 123a set in the microchip 120 described later in a direction different from the optical axes of the excitation light L1, the excitation light L2 and the excitation light L3. Note that the backscattered light detection system 130 to be described later is disposed in a traveling direction of the backscattered light L12 reflected by the perforated mirror 114.

As illustrated in FIG. 3, the perforated mirror 114 is disposed on the optical paths of the excitation light L1, the excitation light L2 and the excitation light L3 such that the optical axes of the excitation light L1, the excitation light L2 and the excitation light L3 pass through substantially the center of the hole 114 a. Here, a diameter of the hole 114a may be, for example, a diameter at which the shortest diameter D of the hole 114a as viewed from an optical axis direction is larger than at least a diameter d of a beam cross section of the collected excitation light L1, excitation light L2, and excitation light L3 when the perforated mirror 114 is installed at an angle θ with respect to the optical axes of the excitation light L1, the excitation light L2 and the excitation light L3. Note that the diameter of the beam cross section may be, for example, a diameter of a region where a beam intensity in the beam cross section is equal to or greater than a predetermined value in a case where the beam cross section is circular.

For example, when the numerical aperture NA of the collected excitation light L1, excitation light L2, and excitation light L3 is 0.15, the numerical aperture of the hole 114a viewed from a direction inclined by the angle θ may be 0.15 or more. However, in a case where the hole 114a is made too large, the backscattered light L12 incident on the backscattered light detection system 130 is reduced. Therefore, the numerical aperture of the hole 114a is preferably as small as possible.

Note that the shape of the reflecting surface and the shape of the hole 114a of the perforated mirror 114 are not limited to a circle, and may be an ellipse, a polygon, or the like. Further, the shape of the reflecting surface and the shape of the hole 114a of the perforated mirror 114 do not need to be in a similar relationship, and may be independent of each other.

Returning to FIG. 1, the description will be made. For example, as illustrated in FIG. 4, the dichroic mirror 115 on which the excitation light L1, the excitation light L2 and the excitation light L3 having passed through the hole 114a are incident is designed to reflect light having a wavelength of 637 nm corresponding to the excitation light L1, light having a wavelength of 488 nm corresponding to the excitation light L2, and light having a wavelength of 405 nm corresponding to the excitation light L3, and transmit light having other wavelengths. Therefore, the excitation light L1, the excitation light L2 and the excitation light L3 incident on the dichroic mirror 115 are reflected by the dichroic mirror 115 and incident on the objective lens 116.

Note that a beam shaping unit for converting the excitation light L1, the excitation light L2 and the excitation light L3 into parallel light may be provided on an optical path from each of the excitation light sources 101 to 103 to the objective lens 116. The beam shaping unit may include, for example, one or more lenses, mirrors, or the like.

The objective lens 116 condenses the incident excitation light L1, excitation light L2, and excitation light L3 on the predetermined spot 123a on a flow path in the microchip 120 to be described later. When the spot 123a is irradiated with the excitation light L1, the excitation light L2 and the excitation light L3 which are pulsed light while the microparticle is passing through the spot 123a, fluorescence is emitted from the microparticle, and the excitation light L1, the excitation light L2 and the excitation light L3 are scattered by the microparticle to generate scattered light.

In the present description, among the scattered light generated from the microparticle in all directions, a component within a predetermined angle range traveling forward in the traveling direction of the excitation light L1, the excitation light L2 and the excitation light L3 is referred to as forward scattered light, a component within a predetermined angle range traveling backward in the traveling direction of the excitation light L1, the excitation light L2 and the excitation light L3 is referred to as backscattered light L12, and a component in a direction deviated from the optical axes of the excitation light L1, the excitation light L2 and the excitation light L3 by a predetermined angle is referred to as side scattered light.

The objective lens 116 has, for example, a numerical aperture corresponding to about 40° to 60° (For example, the angle corresponds to the predetermined angle described above.) with respect to the optical axes. Among the fluorescence emitted from the microparticle, a component (hereinafter, referred to as fluorescence L14) within a predetermined angle range traveling backward in the traveling direction of the excitation light L1, the excitation light L2 and the excitation light L3, and the backscattered light L12 are transmitted through the objective lens 116 and incident on the dichroic mirror 115.

Among the fluorescence L14 and the backscattered light L12 incident on the dichroic mirror 115, the fluorescence L14 is transmitted through the dichroic mirror 115 and incident on the fluorescence detection system 140.

On the other hand, the backscattered light L12 is reflected by the dichroic mirror 115, further reflected by the perforated mirror 114, and incident on the backscattered light detection system 130. Here, in a case where the numerical aperture of the hole 114a of the perforated mirror 114 is set to a numerical aperture (for example, NA≈0.2) of about 20° with respect to the optical axis, and the numerical aperture of the objective lens 116 is set to a numerical aperture of about 40° with respect to the optical axis, the backscattered light L12 within an angle range of about 20° to 40° with respect to the optical axis is incident on the backscattered light detection system 130. That is, the backscattered light L12 having a donut-shaped beam profile is incident on the backscattered light detection system 130.

The backscattered light detection system 130 includes, for example, a plurality of lenses 131, 133, and 135 that shapes a beam cross section of the backscattered light L12 reflected by the perforated mirror 114, a diaphragm 132 that adjusts an amount of light of the backscattered light L12, a mask 134 that selectively transmits light of a specific wavelength (for example, light having a wavelength of 488 nm corresponding to the excitation light L2) among the backscattered light L12, and a photodetector 136 that detects light transmitted through the mask 134 and the lens 135 and incident thereon.

The diaphragm 132 may have, for example, a configuration in which a pinhole-shaped hole is provided in a light shielding plate. The hole may be larger than the width of the hole (region where the laser intensity is reduced) in the central portion of the backscattered light L12 having the donut-shaped beam profile.

The photodetector 136 includes, for example, a two-dimensional image sensor, a photodiode, or the like, and detects a light amount and a size of light that has passed through the mask 134 and the lens 135 and entered. A signal detected by the photodetector 136 is input to, for example, an analysis system 212 described later. Note that, in the analysis system 212, for example, the size or the like of the microparticle may be analyzed on the basis of the input signal.

The fluorescence detection system 140 includes, for example, a spectroscopic optical system 141 that disperses the incident fluorescence L14 into dispersed light L15 for each wavelength, and a photodetector 142 that detects an amount of the dispersed light L15 for each predetermined wavelength band (also referred to as a channel). In addition, the fluorescence detection system 140 includes an image forming lens 143 that collects the fluorescence L14 of collimated light transmitted through the dichroic mirror 115, and a sorting fiber 144 that guides the collected fluorescence L14 to a predetermined position.

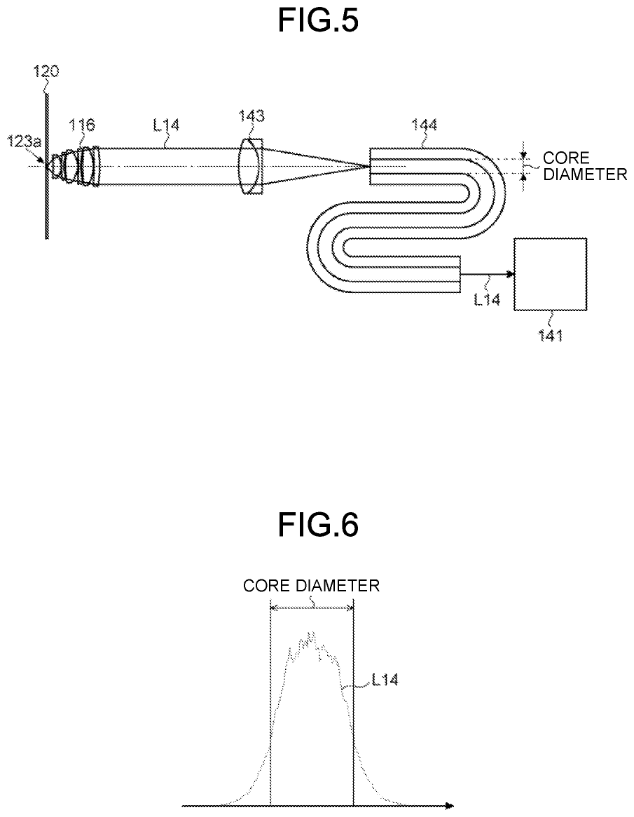

Here, FIG. 5 illustrates a more detailed configuration example of an optical system from the spot 123a in the microchip 120 in FIG. 1 to the spectroscopic optical system 141. Note that, in FIG. 5, the dichroic mirror 115 in FIG. 1 is omitted. As illustrated in FIG. 5, the fluorescence L14 emitted from the spot 123a is converted into collimated light by the objective lens 116, then condensed by the image forming lens 143, and introduced into one end (an incident end) of the sorting fiber 144. Thereafter, the fluorescence L14 is emitted from the other end (an emission end) of the sorting fiber 144 to be guided to the spectroscopic optical system 141.

FIG. 6 is a diagram illustrating an example of a beam diameter of the fluorescence L14 in service at the incident end of the sorting fiber 144 and a core diameter of the sorting fiber 144. An opening (core diameter) of the sorting fiber 144 also serves as a field aperture function of cutting stray light such as excitation light reflected by an end surface of the microchip 120. Therefore, the core diameter of the sorting fiber 144 is desirably as small as possible. For example, the core diameter of the sorting fiber 144 is desirably a size corresponding to the flow path width of the microchip 120.

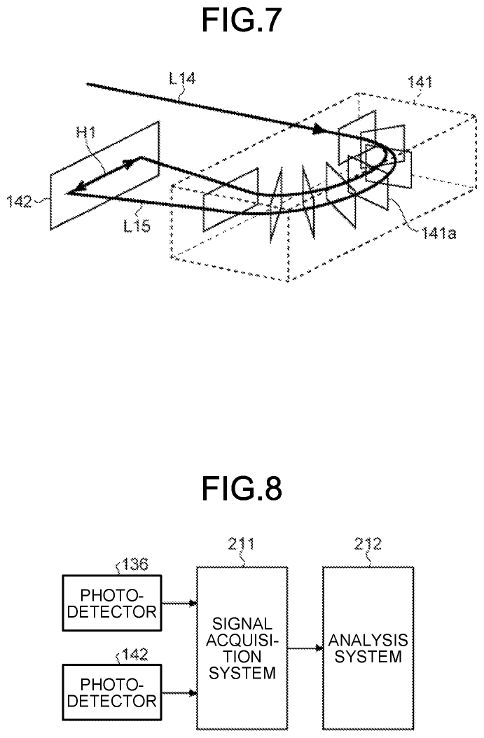

Furthermore, FIG. 7 illustrates an example of the spectroscopic optical system 141 according to the present embodiment. As illustrated in FIG. 7, the spectroscopic optical system 141 includes, for example, one or more optical elements 141a such as a prism and a diffraction grating, and disperses the incident fluorescence L14 into the dispersed light L15 emitted toward different angles for each wavelength.

Returning to FIG. 1, the description will be made. The photodetector 142 may include, for example, a plurality of light receiving units that receives light for each channel. In that case, the plurality of light receiving units may be arranged in one line or two or more lines in a spectroscopic direction H1 by the spectroscopic optical system 141. Furthermore, for each of the light receiving units, for example, a photoelectric conversion element such as a photomultiplier tube can be used. Note that, as the photodetector 142, a two-dimensional image sensor or the like can be used instead of the plurality of light receiving units such as a photomultiplier tube array.

A signal indicating a light amount of the fluorescence L14 for each channel detected by the photodetector 142 is input to, for example, the analysis system 212 described later. Note that, in the analysis system 212, for example, component analysis, morphology analysis, or the like of the microparticle may be executed on the basis of the input signal.

1.2 Schematic Configuration Example of Information Processing System

FIG. 8 is a block diagram illustrating a schematic configuration example of an information processing system according to the present embodiment. As illustrated in FIG. 8, the information processing system includes, for example, an analysis system 212 that acquires a signal from the photodetector 142 and/or the photodetector 136, and analyzes the microparticle on the basis of the acquired signal. Note that signals generated by the photodetectors 136 and 142, respectively, may be various signals such as image data and optical signal information. In addition, the analysis system 212 may be a local personal computer (PC), may be a cloud server, or may be partially a local PC and partially a cloud server. Furthermore, in a case where the cell analyzer 1 is a sorter, the cell analyzer 1 may include a sorting control unit that controls sorting of microparticles (for example, cells) based on an analysis result.

1.3 Timing Control Example Using Forward Scattered Light

Returning to FIG. 1, the description will be made. In the present embodiment, the forward scattered light may be used to specify the timing at which the microparticle passes through the spot 123a set on a flow path in the microchip 120. Therefore, in the present embodiment, the forward scattered light detection system 160 is provided.

Light L16 traveling forward in the traveling direction of the excitation light L1, the excitation light L2 and the excitation light L3 from the microparticle includes forward scattered light, and a component within a predetermined angle range traveling forward in the traveling direction of the excitation light L1, the excitation light L2 and the excitation light L3 among the fluorescence emitted from the microparticle. The filter 151 disposed on a downstream side of the microchip 120 on the optical paths of the excitation light L1, the excitation light L2 and the excitation light L3 selectively transmits, for example, light having a wavelength of 637 nm corresponding to the excitation light L1 (forward scattered light L17) and light having a wavelength of 488 nm corresponding to the excitation light L2 (forward scattered light L18) among these light components, and blocks light having other wavelengths.

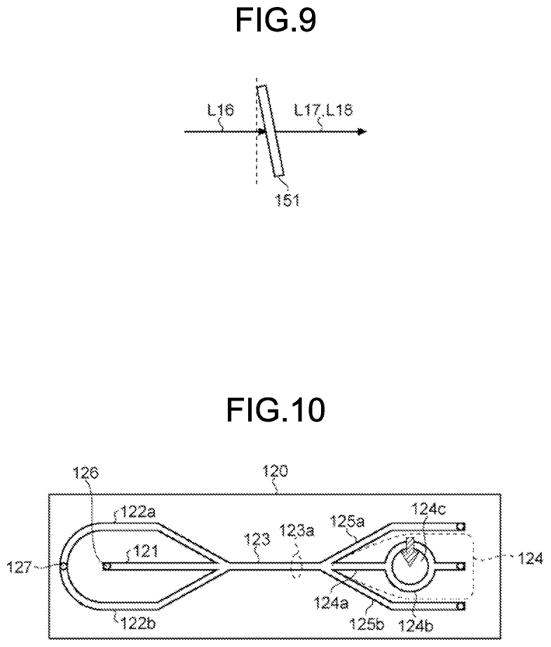

FIG. 9 is a schematic diagram illustrating a filter installed with respect to an optical axis of light traveling forward in a traveling direction of excitation light from a microparticle. As illustrated in FIG. 9, the filter 151 is disposed to be inclined with respect to the optical axis of the light L16. Thus, return light of the light L16 reflected by the filter 151 is prevented from entering the backscattered light detection system 130 and the like via the objective lens 116 and the like.

The forward scattered light L17 and the forward scattered light L18 that have passed through the filter 151 are converted into parallel light by passing through the collimating lens 152, then reflected by the total reflection mirror 153 in a predetermined direction, and incident on the forward scattered light detection system 160.

The forward scattered light detection system 160 includes a lens 161, a dichroic mirror 162a, a total reflection mirror 162b, diaphragms 163a and 163b, lenses 164a and 164b, filters 165a and 165b, diffraction gratings 166a and 166b, and photodetectors 167a and 167b.

The dichroic mirror 162a is designed to reflect the forward scattered light L17 which is scattered light of the excitation light L1 among the forward scattered light L17 and the forward scattered light L18 reflected by the total reflection mirror 153, and transmit the forward scattered light L18 which is scattered light of the excitation light L2.

The lens 161 and the lens 164a function as an optical system that shapes a beam cross section of the forward scattered light L17 traveling on an optical path sandwiched therebetween. The diaphragm 163a adjusts a light amount of the forward scattered light L17 incident on the photodetector 167a. The filter 165a and the diffraction grating 166 a function as an optical filter that increases the purity of the forward scattered light L17 in light incident on the photodetector 167a. The photodetector 167a includes, for example, a photodiode, and detects incidence of the forward scattered light L17.

Similarly, the lens 161 and the lens 164b function as an optical system that shapes a beam cross section of the forward scattered light L18 traveling on an optical path sandwiched therebetween. The diaphragm 163b adjusts a light amount of the forward scattered light L18 incident on the photodetector 167b. The filter 165b and the diffraction grating 166b function as an optical filter that increases the purity of the forward scattered light L18 in light incident on the photodetector 167b. The photodetector 167b includes, for example, a photodiode, and detects incidence of the forward scattered light L18.

As described above, in the present embodiment, two systems of a detection system (the lenses 161 and 164a, the diaphragm 163a, the filter 165a, the diffraction grating 166a, and the photodetector 167a) that detects the forward scattered light L17 and a detection system (the lenses 161 and 164b, the diaphragm 163b, the filter 165b, the diffraction grating 166b, and the photodetector 167b) that detects the forward scattered light L18 are provided as a configuration for detecting the forward scattered light. In this case, the timing detected by one of the detection systems (for example, the detection system that detects the forward scattered light L18) can be compensated for at the timing detected by the other detection system (for example, the detection system that detects the forward scattered light L17). However, the present disclosure is not limited to such a configuration, and for example, either one of the detection systems may be omitted. Note that the timing here may be a timing at which the microparticle passes through the spot 123a set on a flow path in the microchip 120.

1.4 Alignment

Note that, in the above configuration, the optical system for irradiating the spot 123a with the excitation light L1, the excitation light L2 and the excitation light L3 and the detection system for detecting the fluorescence L14 and the backscattered light L12 from the spot 123a, that is, the excitation light sources 101 to 103, the total reflection mirror 111, the dichroic mirrors 112 and 113, the perforated mirror 114, the dichroic mirror 115, and the objective lens 116 may be mounted on the same base 100. In addition, the detection system for detecting the forward scattered light L17 and the forward scattered light L18 from the spot 123a, that is, the backscattered light detection system 130, the fluorescence detection system 140, the filter 151, the total reflection mirror 153, and the forward scattered light detection system 160 may be mounted on the same base 150 different from the base 100. Further, the base 100 and the base 150 may be aligned with each other.

2. Schematic Configuration of Microchip

Next, a microchip according to the present embodiment will be described. FIG. 10 is a diagram schematically illustrating a schematic configuration of a microchip according to the present embodiment. As illustrated in FIG. 10, the microchip 120 of the present embodiment is provided with a sample liquid introduction flow path 121 into which sample liquid 126 containing microparticles is introduced, and a pair of sheath liquid introduction flow paths 122a and 122b into which sheath liquid 127 is introduced. Note that, for example, in a case where an observation target is a biological substance, the microparticles may include a cell, a cell group, a tissue, and the like. However, the present disclosure is not limited thereto, and various microparticles can be observed.

The sheath liquid introduction flow paths 122a and 122b join the sample liquid introduction flow path 121 from both sides, and one joining flow path 123 is provided on a downstream side of the joining point. In the joining flow path 123, the periphery of the sample liquid 126 is surrounded by the sheath liquid 127, and the liquid flows in a state where a laminar flow is formed. As a result, the microparticles in the sample liquid 126 flow side by side in substantially one line with respect to a flow direction.

On the other hand, a negative pressure suction unit 124 for sorting microparticles to be collected, and waste flow paths 125a and 125b for discharging microparticles and the like not to be collected are provided at the downstream end of the joining flow path 123, and both of them communicate with the joining flow path 123. The downstream ends of the waste flow paths 125a and 125b are connected to, for example, a waste liquid tank. In the microchip 120, individual microparticles are detected in the joining flow path 123, and as a result, only the microparticles determined to be a collection target are drawn into the negative pressure suction unit 124, and the other microparticles are discharged from the waste flow paths 125a and 125b.

The configuration of the negative pressure suction unit 124 is not particularly limited as long as the negative pressure suction unit can suck the microparticles to be collected at a predetermined timing. For example, as illustrated in FIG. 10, the negative pressure suction unit can include a suction flow path 124a communicating with the joining flow path 123, a pressure chamber 124b formed in a part of the suction flow path 124a, and an actuator 124c capable of expanding a volume in the pressure chamber 124b at an arbitrary timing. The downstream end of the suction flow path 124a is desirably openable and closable by a valve (not illustrated) or the like.

In addition, the pressure chamber 124b is connected to the actuator 124c such as a piezoelectric element via a diaphragm.

Furthermore, examples of a material for forming the microchip 120 include polycarbonate, cycloolefin polymer, polypropylene, polydimethylsiloxane (PDMS), glass, silicon, and the like. In particular, it is preferable to use a polymer material such as polycarbonate, cycloolefin polymer, or polypropylene because it is excellent in processability and can be replicated at low cost using a molding device. In this way, by adopting the configuration in which plastic molded substrates are bonded, the microchip 120 can be manufactured at low cost.

Note that, as described above, the method of supplying the microparticles to the spot on the flow path in the present embodiment is not limited to the microchip method, and various methods such as a droplet method, a cuvette method, and a flow cell method can be adopted.

3. Effect of Separating Fluorescence and Backscattered Light Using dichroic mirror

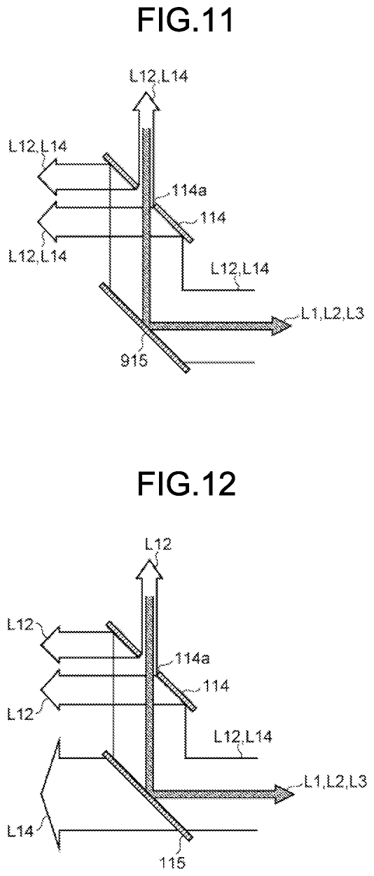

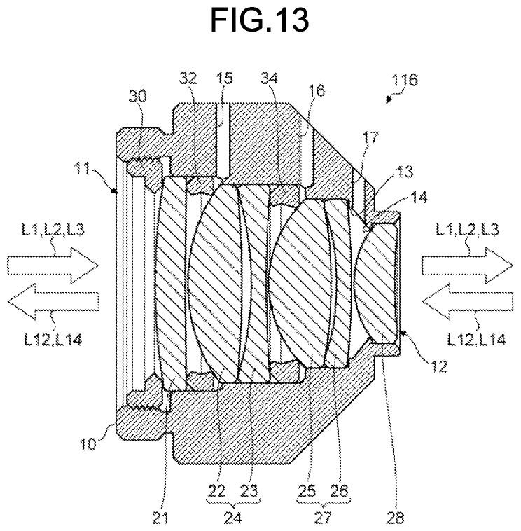

Next, the effect of separating the fluorescence L14 and the backscattered light L12 using the dichroic mirror 115 will be described. FIG. 11 is a diagram for explaining a case where fluorescence and backscattered light according to a comparative example are not separated, and FIG. 12 is a diagram for explaining a case where fluorescence and backscattered light according to the present embodiment are separated.

As illustrated in FIG. 11, in a case where the total reflection mirror 915 is used instead of the dichroic mirror 115, the fluorescence L14 and the backscattered light L12 are not separated and are reflected by the perforated mirror 114 to be incident on the detection system. Note that, in the detection system, a detection system that detects the backscattered light L12 and a detection system that detects the fluorescence L14 are arranged on the optical axes of the fluorescence L14 and the backscattered light L12 reflected by the perforated mirror 114.

As described above, when the fluorescence L14 and the backscattered light L12 are not separated, the fluorescence L14 near the optical axis having a relatively high beam intensity escapes through the hole 114a of the perforated mirror 114. Therefore, the sensitivity of the detection system to the fluorescence L14 decreases, and the detection efficiency and the detection accuracy decrease. Note that the fluorescence L14 and the backscattered light L12 that have passed through the hole 114a may be absorbed by, for example, a beam damper (not illustrated) or the like.

On the other hand, as in the present embodiment illustrated in FIG. 12, by configuring the fluorescence L14 and the backscattered light L12 to be separated by the dichroic mirror 115 before being reflected by the perforated mirror 114, the fluorescence L14 in the vicinity of the optical axis having a relatively high beam intensity can be incident on the fluorescence detection system 140 without discarding it. This makes it possible to suppress a decrease in sensitivity of the fluorescence detection system 140 to the fluorescence L14, so that it is possible to suppress a decrease in detection efficiency and a decrease in detection accuracy.

4. Objective Lens

Next, a schematic configuration example of the objective lens 116 in the above-described embodiment will be described. As in the present embodiment, in the microchip-type flow cytometer, the excitation light L1, the excitation light L2 and the excitation light L3 are emitted substantially perpendicularly to the incident surface of the microchip 120. In such a configuration, it is difficult to observe side scattered light among scattered light scattered by the microparticles. Accordingly, in the present embodiment, the forward scattered light L17 and the forward scattered light L18, and the backscattered light L12 are observed, but among these, the backscattered light L12 is observed as return light via the objective lens 116. Therefore, the objective lens 116 is required to have such optical stability that optical characteristics can be maintained even when the excitation light L1, the excitation light L2 and the excitation light L3 having a strong laser intensity are emitted. For example, even when strong ultraviolet light (for example, the excitation light L3) having a wavelength of 450 nm or less is emitted, high optical stability is required in which optical characteristics are maintained to such an extent that observation of the backscattered light L12 is not hindered.

As the objective lens 116 also used for observing the backscattered light L12, a cemented lens formed by bonding a plurality of lenses can be used in order to enable aberration correction. However, in the cemented lens, an adhesive is usually used to fix individual lenses. Therefore, when the light source of the flow cytometer includes light beams (for example, the excitation light L3) in the ultraviolet (wavelength of 450 nm or less) region, there is a possibility that burning of the adhesive at the lens joint or burning of the outgas released from the adhesive and attached to the lens surface occurs, and the optical characteristics of the cemented lens are deteriorated.

Therefore, in the present embodiment, the objective lens 116 having a novel structure of introduction of a cemented division group and a telephoto configuration is used. By using the objctive lens 116 having such a structure, it is possible to achieve an effect of correcting chromatic aberration and avoiding burning of an adhesive or the like, and at the same time, it is possible to achieve an effect of reducing cost by reducing the number of mechanical components, the number of lenses, and the like.

4.1 Schematic Configuration Example of Objective Lens

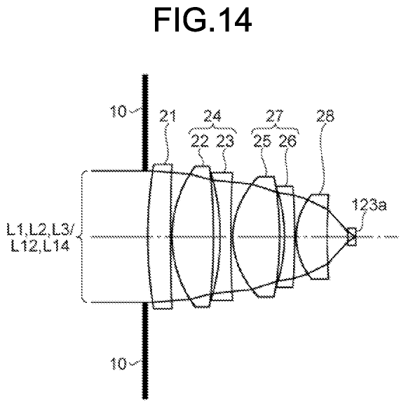

FIG. 13 is a cross-sectional view illustrating a schematic configuration example of the objective lens according to the present embodiment. Note that FIG. 13 illustrates a cross-sectional structure when the objective lens 116 is cut along a plane including the optical axes of the excitation light L1, the excitation light L2 and the excitation light L3. FIG. 14 is an optical path diagram illustrating a light beam of the objective lens illustrated in FIG. 13.

4.1.1 Optical System

The objective lens 116 according to the present embodiment is an infinity correction objective lens. As illustrated in FIG. 13, the objective lens 116 includes a positive-power first lens (hereinafter, referred to as a first positive lens) 21, a positive-power cemented division group 24 as a whole, including a positive-power second lens (hereinafter, referred to as a second positive lens) 22 and a negative-power third lens (hereinafter, referred to as a third negative lens) 23, a positive-power cemented division group 27 as a whole, including a positive-power fourth lens (hereinafter, referred to as a fourth positive lens) 25 and a negative-power fifth lens (hereinafter, referred to as a fifth negative lens) 26, and a positive-power sixth lens (hereinafter, referred to as a sixth positive lens) 28, in this order from the incident side of the excitation light L1, the excitation light L2 and the excitation light L3 and the emission side (infinite distance side) of the fluorescence L14 and the backscattered light L12.

The objective lens 116 has, for example, a focal length of 10 mm, a numerical aperture NA of 0.75, and an objective field of view of Φ0.5 mm, and covers a wavelength band of 405 to 850 nm of the excitation light L1, the excitation light L2 and the excitation light L3 and the fluorescence L13. Since the objective lens 116 having such a configuration has a narrow field of view, the priority order of aberration (magnification color, field curvature, and distortion) correction depending on an angle of view is not high. However, since the numerical aperture NA is large, it is necessary to sufficiently correct the aberration (spherical surface/coma) depending on the aperture of the diaphragm 10 illustrated in FIG. 14. In addition, since the wavelength band is wide, axial chromatic aberration also needs to be sufficiently corrected. Among these aberrations, correction of axial chromatic aberration is particularly important. If the axial chromatic aberration is not corrected, the point image shape of the acquired fluorescence L14 greatly spreads from a paraxial image region and protrudes from the core diameter of the sorting fiber 144, so that the coupling efficiency may be greatly reduced. That is, while the coupling efficiency of the sorting fiber 144 is defined by (an amount of signals entering the core of the sorting fiber 144)/(a total amount of signals on an incident end surface of the sorting fiber 144), as described above, the core diameter of the sorting fiber 144 is desirably as small as possible. Therefore, if the image on the incident end surface of the sorting fiber 144 is blurred due to the influence of the aberration of the lens or the like, the amount of signals entering the core (the amount of light of the fluorescence L14) decreases, and the coupling efficiency decreases. In this case, there is a problem that the detection sensitivity of the cell analyzer 1 decreases.

As a method for solving this problem, it is conceivable to use a plurality of cemented lenses. However, in the present embodiment, since the excitation light L1, the excitation light L2 and the excitation light L3 contain ultraviolet rays (wavelength of 450 nm or less), burning of the ultraviolet curable adhesive used for a bonding surface occurs. As a result, the transmittance may decrease with continuous use, and the detection sensitivity of the cell analyzer 1 may decrease.

Therefore, in the present embodiment, the axial chromatic aberration is corrected using the cemented division group 24 including the second positive lens 22 and the third negative lens 23, and the cemented division group 27 including the fourth positive lens 25 and the fifth negative lens 26, and at the same time, the burning of the bonding adhesive due to the use of the ultraviolet excitation laser (for example, equivalent to the excitation light source 103) is avoided.

Note that, as in the present embodiment, by setting the number of the cemented division groups to two (cemented division groups 24 and 27), it is possible to satisfactorily correct the axial chromatic aberration while suppressing an increase in size and cost of the optical system. However, this description does not exclude that the number of the cemented division groups is one or three or more from the technical scope of the present disclosure, and the number of the cemented division groups may be one or three or more.

In addition, it is preferable to use an abnormally low dispersion material for the second positive lens 22 having positive power and the fourth positive lens 25 having positive power. This makes it possible to contribute to chromatic aberration correction in a wide band.

Note that the general cemented group has three surfaces contributing to aberration correction, whereas the cemented division group has four surfaces. Therefore, the degree of freedom due to the four contribution surfaces can be divided into the spherical and coma aberration correction described above. As a result, it is possible to realize good aberration correction with a small number of components such as six in six groups, and thus, it is possible to reduce the cost.

Note that, as illustrated in FIG. 14, the objective lens 116 according to the present embodiment makes a convergent light beam in advance with weak refractive power of the first positive lens 21 having positive power, and then guides the light beam to the cemented division groups 24 and 27. As a result, since the positive power of each of the cemented division groups 24 and 27 can be weakened, it is possible to suppress the occurrence of aberration as the entire optical system.

In addition, as illustrated in FIG. 13, by using a so-called aplanatic lens for the positive-power sixth positive lens 28, it is possible to contribute to the focal length without generating spherical or coma aberration.

As described above, the objective lens 116 according to the present embodiment has a structure close to a telephoto type. As a result, since the lens outer shape can be gradually reduced from an incident side of the excitation light L1, the excitation light L2 and the excitation light L3, and an emission side (infinite distance side) of the fluorescence L14 and the backscattered light L12 toward an object side, it is possible to design the lens barrel such that all the lenses are fitted into one lens frame 10. This makes it possible to reduce the cost of the mechanical components.

At that time, as illustrated in FIG. 13, the relative position of the cemented division surfaces in the cemented division groups 24 and 27 is preferably determined by a marginal contact in which the curvature surfaces of polished surfaces are directly brought into contact with each other. The reason is as follows.

That is, in the structure of the objective lens 116 according to the present embodiment, since the entire performance is exhibited by canceling the aberration between the cemented division surfaces, when the manufacturing eccentricity occurs between the cemented division surfaces, the performance may be greatly deteriorated. In this regard, even if a lens external dimensional error occurs, the relative eccentricity between the surfaces can be made zero by directly applying the curvature surfaces of the polished surfaces to each other.

Note that the positive lens (second lens 22 and/or fourth lens 25) constituting at least one of the two cemented division groups (24, 27) according to the present embodiment may have a refractive index Nd of 1.6 or less, an Abbe number vd of 65 or more, and a partial dispersion ratio θgF of 0.55 or less. In addition, the refractive index Nd in the present description is a refractive index at d line 587.56 nm, the Abbe number vd is an Abbe number at d line 587.56 nm, and the partial dispersion ratio θgF is a partial dispersion ratio defined by g line 435.834 nm and F line 486.133 nm.

4.1.1.1 Modified Rxample of Optical System

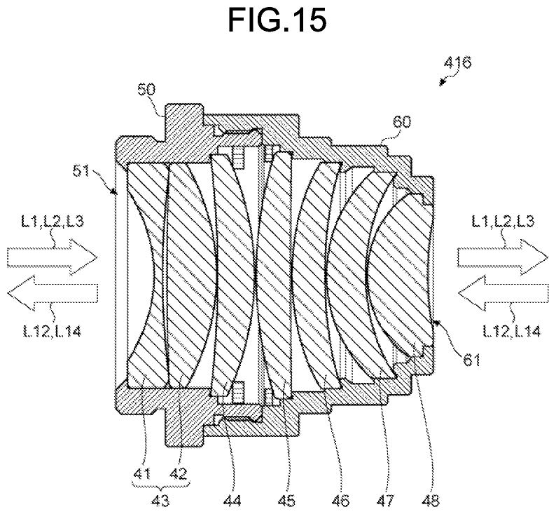

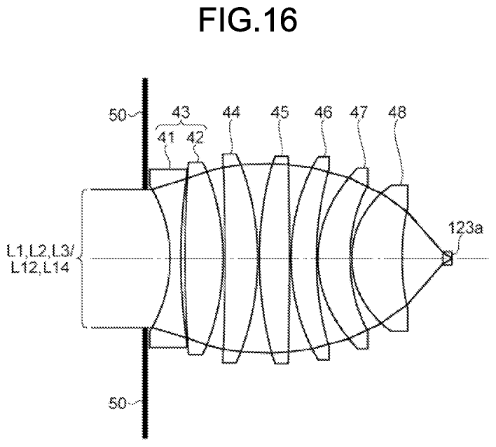

For comparison, FIGS. 15 and 16 illustrate a retrofocus (inverse telephoto) type modification having the same specification as the objective lens 116 described above. Note that a specification example of the objective lenses 116 and 416 will be described in detail later. FIG. 15 is a cross-sectional view illustrating a schematic configuration example of an objective lens according to a modified example, and FIG. 16 is an optical path diagram illustrating a light beam of the objective lens illustrated in FIG. 15.

As illustrated in FIGS. 15 and 16, the objective lens 416 according to the modified example includes a negative power cemented division group 43 as a whole, including a negative power first lens (hereinafter, referred to as a first negative lens) 41 and a positive power second lens (hereinafter, referred to as a second positive lens) 42, and positive power third to seventh lenses (hereinafter, referred to as third to seventh positive lenses) 44 to 48.

In the objective lens 416 according to the modified example, since the image forming performance around the screen is regarded as important, the field curvature is corrected by using the first negative lens 41 having a low light beam height as a negative lens having strong power. Then, the light beam inevitably diverges from the first negative lens 41 to the third positive lens 44, so that the lens outer shape increases toward the middle, and then decreases from the fourth positive lens 45 to the seventh positive lens 48. Therefore, two components, that is, a first lens frame 50 holding the first negative lens 41 to the third positive lens 44, and a second lens frame 60 holding the fourth positive lens 45 to the seventh positive lens 48, are required, which increases the number of components and complicates the assembly process, leading to an increase in manufacturing cost.

On the other hand, according to the objective lens 116 according to the present embodiment, as described above, it is possible to achieve the effects of correcting chromatic aberrations and avoiding burning of an adhesive or the like by the introduction of the cemented division group and the telephoto configuration, and at the same time, it is possible to achieve the effect of reducing the cost by reducing the number of mechanical components, the number of lenses, and the like.

4.1.2 Lens Barrel System

Next, a lens frame holding the above-described optical system will be des cribed. In the assembly of the objective lens 116 illustrated in FIGS. 13 and 14, the sixth positive lens 28 arranged on a side of the microchip 120 is fitted into the lens frame 10 from the opening 12 on the side of the microchip 120. On the other hand, the first positive lens 21, the second positive lens 22, the third negative lens 23, the fourth positive lens 25, and the fifth negative lens 26 are fitted into the lens frame 10 from the opening 11 on the incident side of the excitation light L1, the excitation light L2 and the excitation light L3 and on the emission side (infinite distance side) of the fluorescence L14 and the backscattered light L12 in ascending order of diameter. Therefore, in the present embodiment, the first positive lens 21, the second positive lens 22, the third negative lens 23, the fourth positive lens 25, the fifth negative lens 26, and the sixth positive lens 28 are arranged along the optical axes of the excitation light L1, the excitation light L2 and the excitation light L3 in the order of larger diameters in a direction perpendicular to the optical axes.

The inside of lens frame 10 is reduced in diameter stepwise in accordance with the diameters of the first positive lens 21, the second positive lens 22, the third negative lens 23, the fourth positive lens 25, and the fifth negative lens 26.

Therefore, the fifth negative lens 26 first fitted from a side of the opening 11 is fixed in the lens frame 10 by abutting on an abutting portion 13 in the lens frame 10 and making a marginal contact with the fourth positive lens 25.

The fourth positive lens 25 is in marginal contact with the fifth negative lens 26, and is fixed in the lens frame 10 by being in contact with an interval ring 34 functioning as a spacer.

Note that, for example, the diameters of the fourth positive lens 25 and the fifth negative lens 26 are approximately the same, and the diameters of portions where the fourth positive lens 25 and the fifth negative lens 26 are located inside the lens frame 10 are designed so that the fourth positive lens 25 and the fifth negative lens 26 just fit. Further, the interval ring 34 has a ring shape in which a center is opened, and is fitted into the lens frame 10 before the third negative lens 23 is fitted into the lens frame 10 after the fourth positive lens 25 is fitted into the lens frame 10. An outer diameter of the interval ring 34 may be, for example, approximately the same as the third negative lens 23 and the second positive lens 22.

The third negative lens 23 is fixed in the lens frame 10 by abutting on the interval ring 34 fitted in the lens frame 10 and making marginal contact with the second positive lens 22. At this time, the interval ring 34 is fixed in the lens frame 10 by being sandwiched between the fourth positive lens 25 and the third negative lens 23.

The second positive lens 22 is in marginal contact with the third negative lens 23 and is fixed in the lens frame 10 by abutting on an interval ring 32 functioning as a spacer.

Note that, for example, the diameters of the second positive lens 22 and the third negative lens 23 are substantially the same, and the diameters of portions where the second positive lens 22 and the third negative lens 23 are located inside the lens frame 10 are designed so that the second positive lens 22 and the third negative lens 23 are exactly fitted. Further, the interval ring 32 has a ring shape in which a center is opened, and is fitted into the lens frame 10 before the first positive lens 21 is fitted into the lens frame 10 after the second positive lens 22 is fitted into the lens frame 10. An outer diameter of the interval ring 32 may be, for example, about the same as that of the first positive lens 21 or about the same as that of the second positive lens 22.

The first positive lens 21 is fixed in the lens frame 10 by abutting on the interval ring 32 fitted in the lens frame 10 and abutting on the first positive lens 21 by rotating an attachment screw 30 with the center opened in the screw frame provided on the side of the opening 11.

Note that, for the lens frame 10, for example, a metal such as aluminum or brass, an alloy, or the like can be used. Furthermore, metal such as aluminum or copper, an alloy, or the like can be used for the interval rings 32 and 34 and the attachment screw 30. However, the material is not limited to these materials, and various materials can be adopted in consideration of price, ease of processing, durability, and the like.

Further, the lens frame 10 may be provided with an air hole 17 for releasing air inside when the fifth negative lens 26 or the sixth positive lens 28 is fitted into the lens frame 10, an air hole 16 for releasing air inside when the third negative lens 23 is fitted into the lens frame 10, and an air hole 15 for releasing air inside when the first positive lens 21 is fitted into the lens frame 10.

4.2 Effect of Structure Not Using Adhesive

As described above, the entire plurality of lenses (the first positive lens 21, the second positive lens 22, the third negative lens 23, the fourth positive lens 25, and the fifth negative lens 26) is sandwiched between the lens frame 10 and the attachment screw 30, and each lens is fixed by the marginal contact between the lenses and the contact with the interval ring 32 or 34, whereby the relative position between the cemented division surfaces can be fixed without using an adhesive.

That is, the second positive lens 22 and the third negative lens 23, and the fourth positive lens 25 and the fifth negative lens 26 are positioned to each other by a marginal contact in which they abut each other. In addition, the first positive lens 21 and the second positive lens 22, and the third negative lens 23 and the fourth positive lens 25 are positioned to each other by abutting on the interval rings 32 and 34 interposed therebetween. Further, the first positive lens 21, the second positive lens 22, the third negative lens 23, the fourth positive lens 25, and the fifth negative lens 26 as a whole are fixed in the lens frame 10 by the fifth negative lens 26 abutting on the abutting portion 14 of the lens frame 10 and the first positive lens 21 being biased by the attachment screw 30.

With such an adhesive-less structure, it is possible to prevent burning of the adhesive, burning of outgas adhering to the lens surface released from the adhesive, and the like, and thus it is possible to suppress deterioration of optical characteristics of the cemented lens.

The sixth positive lens 28 fitted from a side of the opening 12 is held by the lens frame 10 by being brought into contact with the abutting portion 14 in the lens frame 10. At this time, since the sixth positive lens 28 is not sealed by the lens frame 10, it may be fixed to the lens frame 10 using an adhesive or the like. However, the present disclosure is not limited thereto, and the sixth positive lens 28 may be fixed to the lens frame 10 by covering the opening 12 with a cap whose central part is opened.

In addition, since the objective lens 116 according to the present embodiment can hold the plurality of lenses (21, 22, 23, 25, 26, and 28) with one lens frame 10, it is also possible to achieve effects of cost reduction due to reduction in the number of parts and simplification of an assembly process.

Furthermore, in the objective lens 116 according to the present embodiment, since there are two cemented division groups (cemented division groups 24 and 27), it is possible to satisfactorily correct axial chromatic aberration while suppressing an increase in size and cost of the optical system. In addition, for example, it is possible to reduce the number of lenses as compared with the objective lens 416 according to the modified example. Therefore, it is also possible to achieve effects of cost reduction due to reduction in the number of parts and simplification of the assembly process.

Although the embodiments of the present disclosure have been described above, the technical scope of the present disclosure is not limited to the above-described embodiments as it is, and various modifications can be made without departing from the gist of the present disclosure. In addition, components of different embodiments and modified examples may be appropriately combined.

5. Specific Example of Objective Lens

Next, specific examples of the objective lens 116 according to the present embodiment will be described with some examples.

5.1 First Specific Example

First, a first specific example of the objective lens 116 will be described. In the first specific example, a case where the objective lens 116 is configured using one cemented division group will be exemplified.

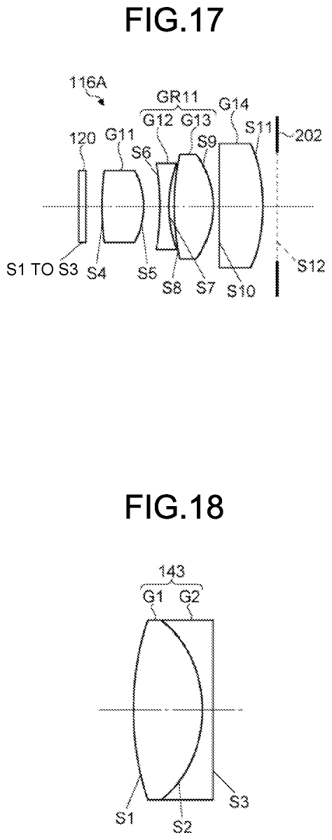

FIG. 17 is a cross-sectional view illustrating a schematic configuration example of the objective lens according to the first specific example. FIG. 18 is a cross-sectional view illustrating a schematic configuration example of an image forming lens used in combination with the objective lens according to the first to third specific examples. Table 1 below illustrates an example of lens data of each lens constituting an objective lens 116A according to the first specific example, and Table 2 illustrates an example of lens data of the image forming lens 143.

TABLE 1

| Surface | Curvature | Thickness/ | Refractive | Abbe |
|---|---|---|---|---|
| number S | radius R | interval D | index Nd | number vd |
| 1 | ∞ | 0.1000 | 1.33304 | 55.72 |
| 2 | ∞ | 0.9000 | 1.53196 | 56.19 |
| 3 | ∞ | 1.8053 | | |
| 4 | 30.2306 | 4.6334 | 1.88299 | 40.76 |
| 5 | −8.2350 | 1.7985 | | |
| 6 | −16.7708 | 1.2000 | 1.84666 | 23.77 |
| 7 | 18.3509 | 0.3296 | | |
| 8 | 31.1451 | 4.6579 | 1.53775 | 74.70 |
| 9 | −9.5343 | 0.3860 | | |
| 10 | 99.3145 | 5.1014 | 1.59522 | 67.73 |
| 11 | −19.4038 | 0.3000 | | |
| 12 (Diaphragm) | ∞ | | | |

TABLE 2

| Surface | Curvature | Thickness/ | Refractive | Abbe |
|---|---|---|---|---|
| number S | radius R | interval D | index Nd | number vd |
| 1 | 37.0111 | 8.0148 | 1.49699 | 81.54 |
| 2 | −15.6610 | 1.2000 | 1.51822 | 58.90 |
| 3 | −148.7246 | | | |

Note that FIGS. 17 and 18 and Tables 1 and 2 exemplify a case where a focal length fo of the objective lens 116A is 10 mm, an object-side numerical aperture NA of the objective lens 116A is 0.65, a magnification β is 6.5, a partial dispersion ratio θgF of G13 (glass material of an S8 surface) is 0.5392, a focal length fi of the image forming lens 143 is 65 mm, and an interval between the objective lens 116A and the image forming lens 143 is 66.0 mm.

In Tables 1 and 2, S represents a surface number, R represents a curvature radius, Nd represents a refractive index with respect to the d line, and vd represents an Abbe number with respect to the d line. Further, in Table 1, a surface having a surface number S1 (hereinafter, referred to as an S1 surface. The same applies to other surface numbers) is an object surface of microparticles to be observed, an S1 surface to an S3 surface are surfaces on the side of the microchip 120, an S4 surface is an incident surface of the objective lens 116A, and an S12 surface is an emission surface of the objective lens 116A. Furthermore, in Table 2, the S1 surface is an incident surface of the image forming lens 143, and the S3 surface is an emission surface of the image forming lens 143.

As illustrated in FIGS. 17 and 18 and Tables 1 and 2, the objective lens 116A according to the first specific example includes, in order from an upstream side, that is, the side closer to the microchip 120, a positive lens G11 having positive refractive power, a negative lens G12 having negative refractive power, a positive lens G13 having positive refractive power, and a positive lens G14 having positive refractive power. The negative lens G12 and the positive lens G13 constitute a cemented division group GR11.

For example, the positive lens G11 is a biconvex lens, the negative lens G12 is a biconcave lens, the positive lens G13 is a biconvex lens, and the positive lens G14 is a biconvex lens.

The image forming lens 143 is used integrally with the objective lens 116A. The image forming lens 43 includes, for example, a cemented lens including a positive lens G1 having positive refractive power and a negative lens G2 having negative refractive power. The positive lens G1 is, for example, a biconvex lens having a partial dispersion ratio θgF of 0.5375, and the negative lens G2 is, for example, a meniscus lens having a concave surface facing the object side.

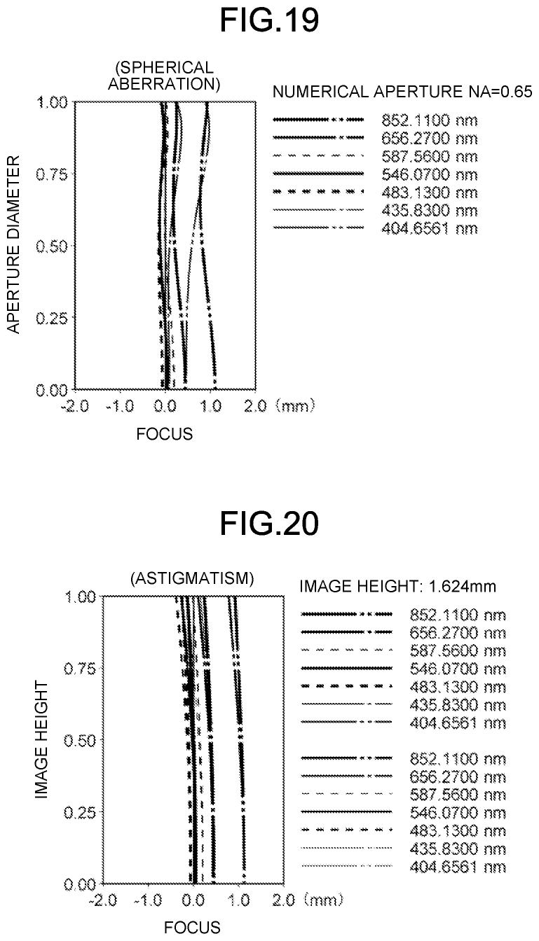

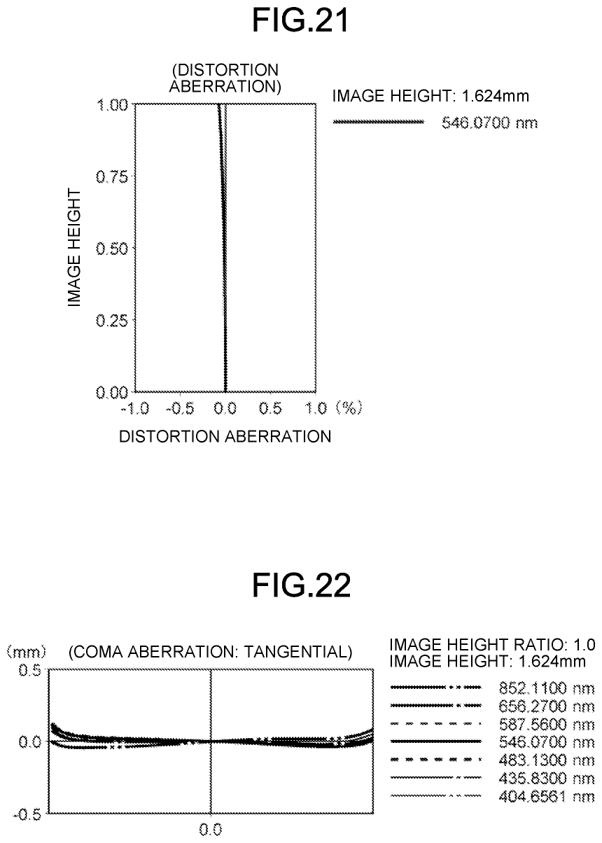

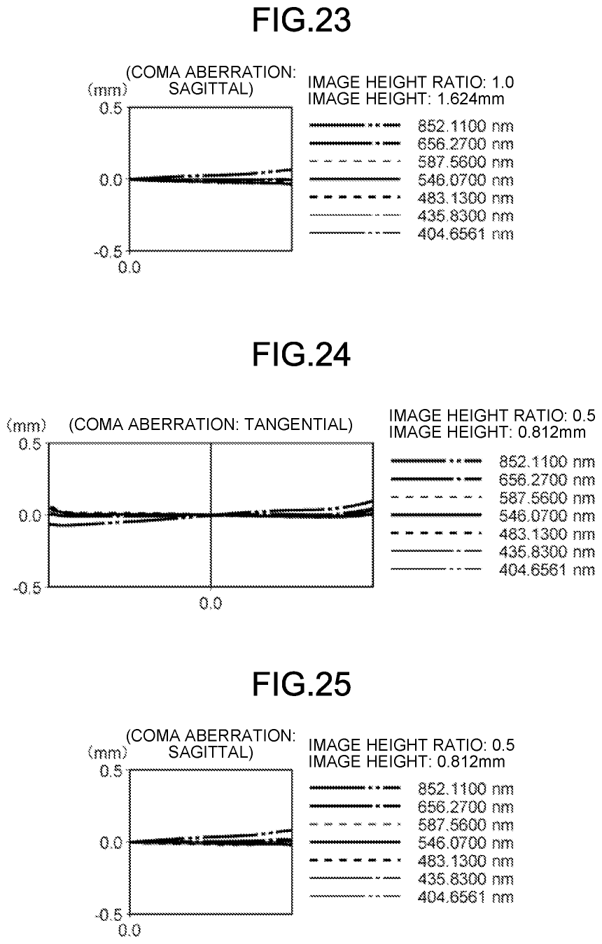

FIGS. 19 to 21 are diagrams illustrating examples of longitudinal aberration of an optical system in which the objective lens and the image forming lens according to the first specific example are combined, and FIGS. 22 to 25 are diagrams illustrating examples of lateral aberration of the optical system in which the objective lens and the image forming lens according to the first specific example are combined. As illustrated in FIGS. 19 to 21 and FIGS. 22 to 25, the objective lens 116A according to the first specific example can satisfactorily correct aberration in a wide wavelength band from 404.656 nm to 852.110 nm.

### 5.2 Second Specific Example

First, a second specific example of the objective lens 116 will be described. In the second specific example, similarly to the objective lens 116 described above with reference to FIGS. 13 and 14, a case where the objective lens 116 is configured using two cemented division groups will be exemplified.

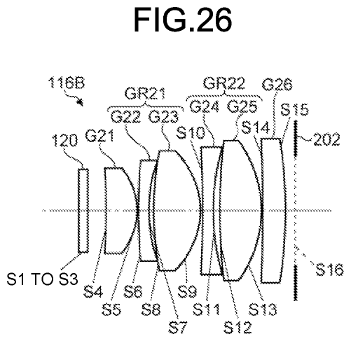

FIG. 26 is a cross-sectional view illustrating a schematic configuration example of an objective lens according to the second specific example. Note that an image forming lens 143 may be similar to the image forming lens 143 exemplified above with reference to FIG. 18 and Table 2. Table 3 below illustrates an example of lens data of each lens constituting an objective lens 116B according to the second specific example.

TABLE 3

| Surface | Curvature | Thickness/ | Refractive | Abbe |
|---|---|---|---|---|
| number S | radius R | interval D | index Nd | number vd |
| 1 | ∞ | 0.1000 | 1.33304 | 55.72 |
| 2 | ∞ | 0.9000 | 1.53196 | 56.19 |
| 3 | ∞ | 2.2182 | | |
| 4 | −42.1923 | 3.5082 | 1.88299 | 40.76 |
| 5 | −7.7066 | 0.1000 | | |
| 6 | 57.6763 | 1.2000 | 1.85477 | 24.79 |
| 7 | 19.1185 | 0.5103 | | |
| 8 | 37.2859 | 5.1716 | 1.49699 | 81.54 |
| 9 | −9.7425 | 0.2599 | | |
| 10 | −81.3027 | 1.2000 | 1.85477 | 24.79 |
| 11 | 25.6949 | 0.7231 | | |
| 12 | 69.6548 | 4.5854 | 1.49699 | 81.54 |
| 13 | −13.9588 | 0.1500 | | |
| 14 | −92.9753 | 2.5910 | 1.88299 | 40.76 |
| 15 | −38.0748 | 0.3000 | | |
| 16 (Diaphragm) | ∞ | | | |

FIG. 26 and Table 3 illustrate a case where a focal length fo of the objective lens 116B is 10 mm, an object-side numerical aperture NA of the objective lens 116B is 0.75, a magnification β is 6.5, a partial dispersion ratio θgF of G23 (glass material of an S8 surface) and a partial dispersion ratio θgF of G25 (glass material of an S12 surface) are both 0.5375, and an interval between the objective lens 116B and the image forming lens 143 is 66.0 mm.

In Table 3, an S1 surface is an object surface of microparticles to be observed, the S1 surface to an S3 surface are surfaces on the side of the microchip 120, an S4 surface is an incident surface of the objective lens 116B, and an S16 surface is an emission surface of the objective lens 116B.

As illustrated in FIG. 26 and Table 3, the objective lens 116B according to the second specific example includes, in order from an upstream side, that is, the side closer to the microchip 120, a positive lens G21 having positive refractive power, a negative lens G22 having negative refractive power, a positive lens G23 having positive refractive power, a negative lens G24 having negative refractive power, a positive lens G25 having positive refractive power, and a positive lens G26 having positive refractive power. The negative lens G22 and the positive lens G23 constitute a cemented division group GR21, and the negative lens G24 and the positive lens G25 constitute a cemented division group GR22.

For example, the positive lens G21 is a meniscus lens having a concave surface facing the side of the microchip 120, and the negative lens G22 is a meniscus lens having a concave surface facing a side of the sorting fiber 144. Further, for example, the positive lens G23 is a biconvex lens, the negative lens G24 is a biconcave lens, the positive lens G25 is a biconvex lens, and the positive lens G26 is a meniscus lens with a concave surface facing the side of the microchip 120.

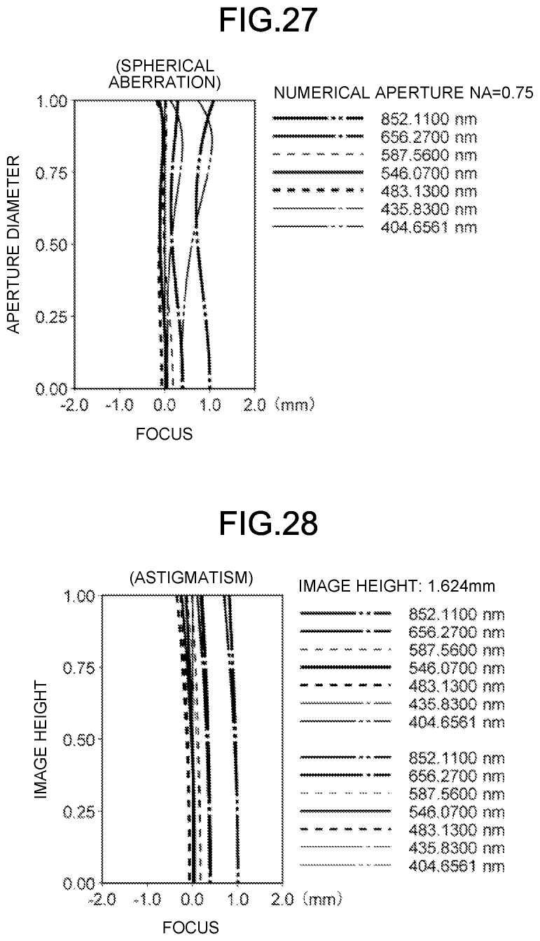

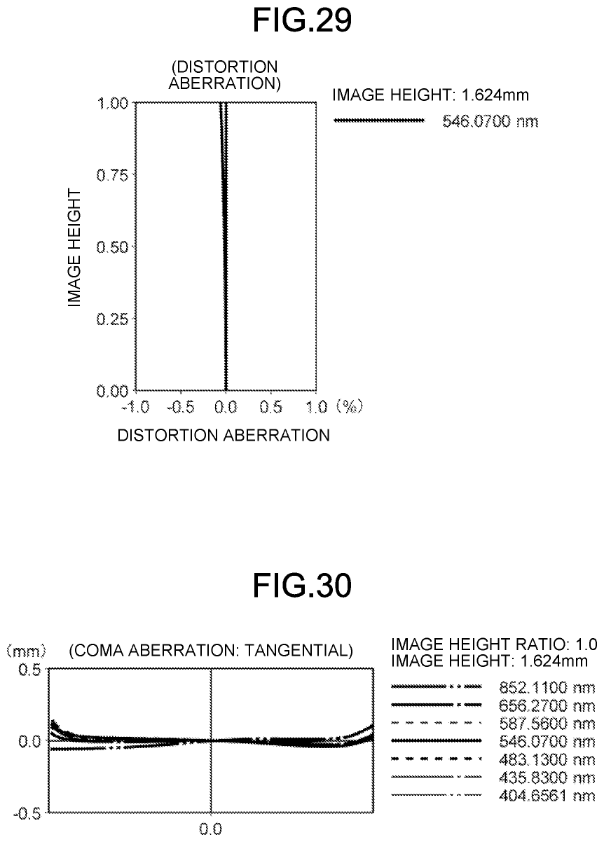

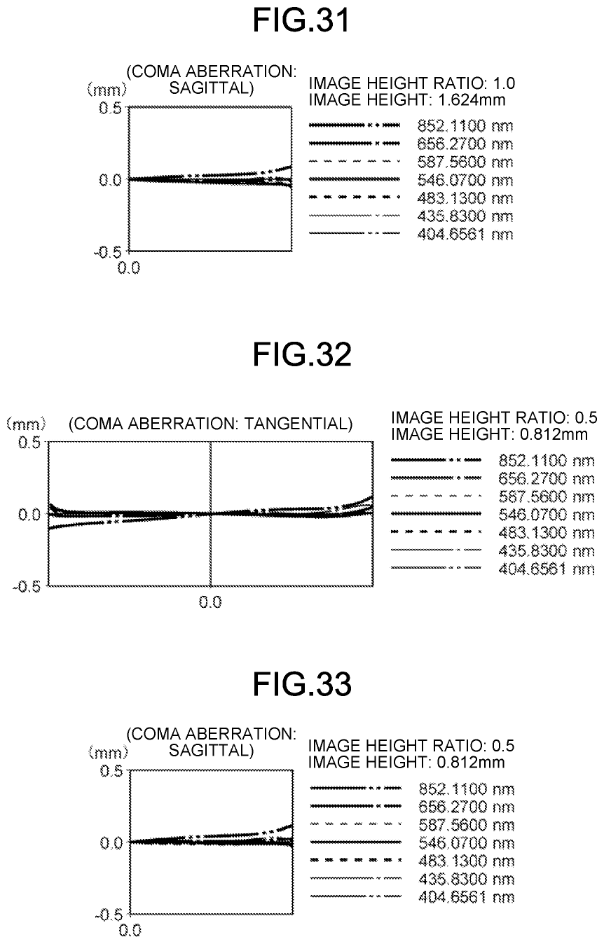

FIGS. 27 to 29 are diagrams illustrating examples of longitudinal aberration of an optical system in which the objective lens and the image forming lens according to the second specific example are combined, and FIGS. 30 to 33 are diagrams illustrating examples of lateral aberration of the optical system in which the objective lens and the image forming lens according to the second specific example are combined. As illustrated in FIGS. 27 to 29 and FIGS. 30 to 33, the objective lens 116B according to the second specific example can also satisfactorily correct the aberration in a wide wavelength band from 404.656 nm to 852.110 nm.

5.3 Third Specific Example

First, a third specific example of the objective lens 116 will be described. In the third specific example, similarly to the objective lens 416 described above with reference to FIGS. 15 and 16, a case where an objective lens 416A of a retrofocus (reverse telephoto) type is configured will be described.

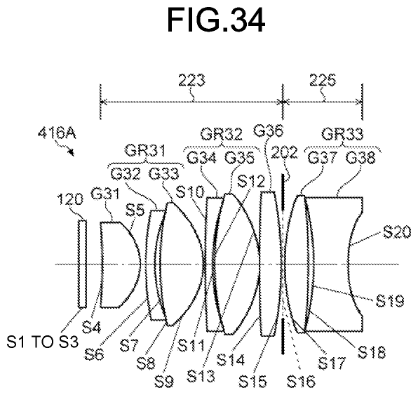

FIG. 34 is a cross-sectional view illustrating a schematic configuration example of an objective lens according to the third specific example. Note that an image forming lens 143 may be similar to the image forming lens 143 exemplified above with reference to FIG. 18 and Table 2. Table 4 below illustrates an example of lens data of each lens constituting the objective lens 416A according to the third specific example.

TABLE 4

| Surface | Curvature | Thickness/ | Refractive | Abbe |
|---|---|---|---|---|
| number S | radius R | interval D | index Nd | number vd |
| 1 | ∞ | 0.1000 | 1.33304 | 55.72 |
| 2 | ∞ | 0.9000 | 1.53196 | 56.19 |
| 3 | ∞ | 2.4109 | | |
| 4 | −36.3576 | 5.6721 | 1.88299 | 40.76 |
| 5 | −9.7479 | 0.9353 | | |
| 6 | 63.8926 | 1.2000 | 1.85895 | 22.72 |
| 7 | 27.4713 | 0.8606 | | |
| 8 | 56.7468 | 6.4053 | 1.43875 | 94.94 |
| 9 | −13.9810 | 0.1500 | | |
| 10 | 193.6238 | 1.2000 | 1.85477 | 24.79 |
| 11 | 36.3099 | 0.4000 | | |
| 12 | 46.3585 | 6.5458 | 1.43875 | 94.94 |
| 13 | −18.6294 | 0.1500 | | |
| 14 | 1208.9110 | 3.1314 | 1.88299 | 40.76 |
| 15 | −65.6496 | 0.3000 | | |
| 16 (Diaphragm) | ∞ | 0.3000 | | |
| 17 | 37.9299 | 3.2479 | 1.88299 | 40.76 |
| 18 | −135.8931 | 0.9638 | | |
| 19 | −44.4386 | 5.1169 | 1.59270 | 35.31 |
| 20 | 18.8598 | | | |

Noted that FIG. 34 and Table 4 illustrate a case where a focal length fo of the objective lens 416A is 10 mm, an object-side numerical aperture NA of the objective lens 416A is 0.85, a magnification β is 6.5, a partial dispersion ratio θgF of G33 (glass material of an S8 surface) and a partial dispersion ratio θgF of G35 (glass material of an S12 surface) are both 0.5340, and an interval between the objective lens 416A and the image forming lens 143 is 66.0 mm.

In Table 4, an S1 surface is an object surface of microparticles to be observed, the S1 surface to an S3 surface are surfaces on the side of the microchip 120, an S4 surface is an incident surface of the objective lens 416A, and an S20 surface is an emission surface of the objective lens 416A.

As illustrated in FIG. 34 and Table 4, the objective lens 416A according to the third specific example is configured by combining a first lens group 223 including a positive lens G31 having positive refractive power, a negative lens G32 having negative refractive power, a positive lens G33 having positive refractive power, a negative lens G34 having negative refractive power, a positive lens G35 having positive refractive power, and a positive lens G36 having positive refractive power, and a second lens group 225 including a positive lens G37 having positive refractive power and a negative lens G38 having negative refractive power in order from an upstream side, that is, the side closer to the microchip 120. The negative lens G32 and the positive lens G33 constitute a cemented division group GR31, the negative lens G34 and the positive lens G35 constitute a cemented division group GR32, and the positive lens G37 and the negative lens G38 constitute a cemented division group GR33.

In the first lens group 223, the positive lens G31 is, for example, a meniscus lens having a concave surface facing the side of the microchip 120. The negative lens G32 is, for example, a meniscus lens having a concave surface facing the side of the sorting fiber 144, and the positive lens G33 is, for example, a biconvex lens. The negative lens G34 is, for example, a meniscus lens having a concave surface facing the side of the sorting fiber 144, and the positive lens G35 is, for example, a biconvex lens. The positive lens G36 is, for example, a biconvex lens.

On the other hand, in the second lens group 225, the positive lens G37 is, for example, a biconvex lens, and the negative lens G38 is, for example, a biconcave lens.

In the objective lenses 116 and 416, since the light amounts of the fluorescence L14 and the backscattered light L12 can be increased by increasing the numerical aperture NA, a signal-to-noise ratio can be improved.

However, when the numerical aperture NA is increased, spherical aberration may increase. Therefore, in the third specific example, the cemented division group GR33 is used as the second lens group 225 including the positive lens G37 and the negative lens G38. As a result, it is possible to cancel the negative spherical aberration generated by the positive refractive power of the positive lenses G31, G33, G35, G36, and G37 with the positive spherical aberration generated by the negative refractive power of the negative lens G38, and thus, it is possible to reduce the spherical aberration as a whole.

When the numerical aperture NA is increased, the aplanatic property is enhanced in order to suppress the aberration. Then, a principal point on the object side (in this example, the side of the microchip 120) moves to an image side (in this example, the side of the sorting fiber 144), and refractive power arrangement is so-called telephoto. In that case, since a working distance is shortened, it is necessary to shorten the distance between the objective lens 116 or 416 and the microchip 120. As a result, there is a possibility that the lens barrel of the objective lens 116 or 416 and the mechanical components around the microchip 120 interfere with each other.

Therefore, in the third specific example, the cemented division group GR33 including the positive lens G37 and the negative lens G38 is provided on the side of the sorting fiber 144. Due to the negative refractive power of the negative lens G38, the telephoto configuration can be relaxed to be close to the retrofocus configuration, and the working distance can be secured. Therefore, interference between the lens barrel of the objective lens 116 or 416 and the mechanical components around the microchip 120 can be suppressed.

Furthermore, when many elements having positive refractive power (in this example, positive lenses G31, G33, G35, G36, and G37 are used) are used, the Petzval coefficient increases positively, and a negative field curvature occurs. As a method of correcting this, a method of using a glass material having a high refractive index for a lens having positive refractive power and using a glass material having a low refractive index for a lens having negative refractive power is conceivable. However, the refractive index of a generally available glass material is about 1.40 to 2.15, and it is difficult to provide a sufficient difference in refractive index.

In addition, in the case of the objective lenses 116 and 416, since priority is given to the viewpoint of suppressing chromatic aberration, it is necessary to use a glass material having a low refractive index and a large Abbe number vd (that is, the dispersion is small) for a lens having positive refractive power. Therefore, in a method using glass materials having different refractive indexes, it is difficult to sufficiently suppress negative field curvature.

Therefore, in the third specific example, the cemented division group GR33 including the positive lens G37 and the negative lens G38 is provided. Since it is possible to cancel the positive Petzval coefficient generated by the positive refractive power of the positive lenses G31, G33, G35, G36, and G37 with the negative Petzval coefficient generated by the strong negative refractive power of the negative lens G38, it is possible to sufficiently suppress the negative field curvature.

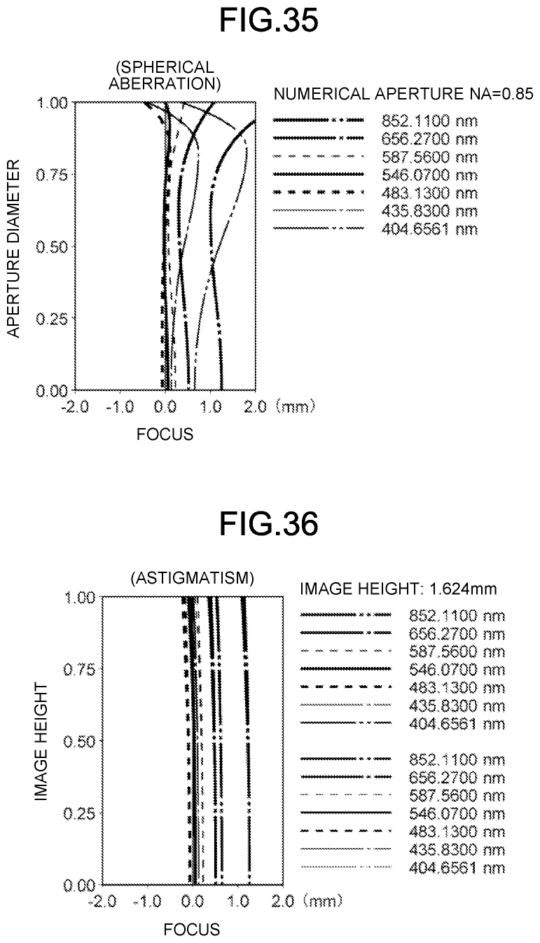

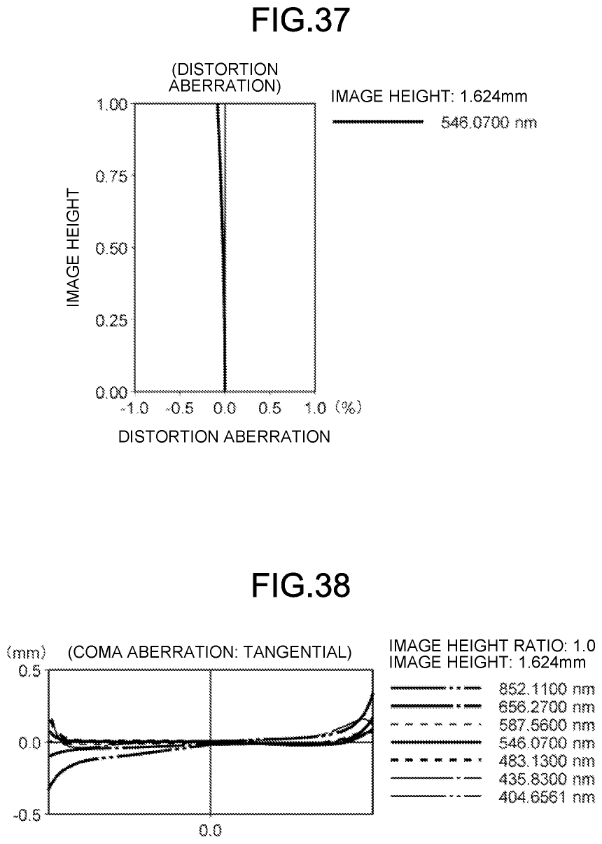

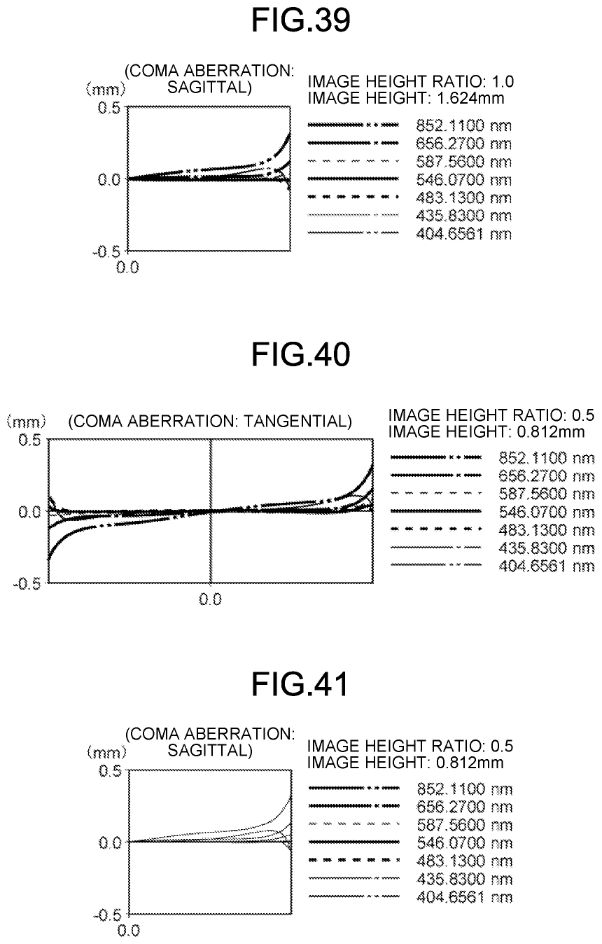

FIGS. 35 to 37 are diagrams illustrating examples of longitudinal aberration of an optical system in which the objective lens and the image forming lens according to the third specific example are combined, and FIGS. 38 to 41 are diagrams illustrating examples of lateral aberration of the optical system in which the objective lens and the image forming lens according to the third specific example are combined. As illustrated in FIGS. 35 to 37 and FIGS. 38 to 41, the objective lens 416A according to the third specific example can also satisfactorily correct aberration in a wide wavelength band from 404.656 nm to 852.110 nm.

Furthermore, the effects of each embodiment described in the present specification are merely examples and are not limited, and other effects may be provided.

Note that the present technique can also have configurations below.

(1)

An optical measurement device includes:

an excitation light source that emits excitation light having a wavelength of at least 450 nanometers or less;

a lens structure that condenses the excitation light at a predetermined position;

a fluorescence detection system that detects fluorescence emitted from a particle by excitation of the particle present at the predetermined position by the excitation light; and

a scattered light detection system that detects scattered light generated by the excitation light being scattered by the particle present at the predetermined position, and

the lens structure includes a plurality of lenses arranged along an optical axis of the excitation light, and a lens frame that holds the plurality of lenses, and

a position of at least one of the plurality of lenses in the lens frame is determined by abutting on a lens adjacent to the lens.

(2)

The optical measurement device according to (1) described above, in which the scattered light detection system detects scattered light having passed through the lens structure.

(3)

The optical measurement device according to (1) or (2) described above, in which

the lens structure further includes at least one interval ring interposed between the plurality of lenses, and

a position of at least one of the plurality of lenses in the lens frame is determined by abutting on the interval ring interposed between the lens and a lens adjacent to the lens.

(4)

The optical measurement device according to any one of (1) to (3) described above, in which

the plurality of lenses includes at least one cemented division group including a positive lens having positive refractive power and a negative lens having negative refractive power, and

the positive lens and the negative lens constituting the cemented division group are in contact with each other.

(5)

The optical measurement device according to (4) described above, in which the at least one cemented division group is one of the cemented division group.

(6)

The optical measurement device according to (4) described above, in which the at least one cemented division group is two of the cemented division groups.

(7)

The optical measurement device according to (4) described above, in which the at least one cemented division group is three of the cemented division groups.

(8)

The optical measurement device according to any one of (4) to (7) described above, in which the positive lens constituting at least one of the at least one cemented division group has a refractive index of 1.6 or less, an Abbe number of 65 or more, and a partial dispersion ratio of 0.55 or less.

(9)

The optical measurement device according to any one of (4) to (8) described above, in which

the plurality of lenses further includes:

a first single lens having positive refractive power; and

a second single lens having positive refractive power, and

the first single lens and the second single lens are disposed at positions sandwiching the at least one cemented division group.

(10)

The optical measurement device according to (4) described above, in which

the at least one cemented division group includes two or more of the cemented division groups, and

two cemented division groups adjacent to each other among the two or more cemented division groups are positioned to each other by abutting on an interval ring interposed between the two cemented division groups.

(11)

The optical measurement device according to any one of (1) to (10) described above, in which the plurality of lenses is arranged along an optical axis of the excitation light in descending order of diameters in a direction perpendicular to the optical axis.

(12)

The optical measurement device according to (11) described above, in which the lens frame is a single member.

(13)

The optical measurement device according to any one of (1) to (12) described above, in which the scattered light is backscattered light propagating along an optical path of the excitation light from the predetermined position.

(14)

The optical measurement device according to any one of (1) to (13) described above, in which an adhesive is not used to fix the plurality of lenses.

(15)

A lens structure that condenses at a predetermined position excitation light emitted from an excitation light source that emits excitation light having a wavelength of at least 450 nanometers or less, the lens structure including:

a plurality of lenses arranged along an optical axis of the excitation light; and

a lens frame that holds the plurality of lenses,

in which a position of at least one of the plurality of lenses in the lens frame is determined by abutting on a lens adjacent to the lens.

### REFERENCE SIGNS LIST

1 CELL ANALYZER

10 LENS FRAME

11, 12 OPENING

13, 14 ABUTTING PORTION

15 to 17 AIR HOLE

FIRST POSITIVE LENS

SECOND POSITIVE LENS

THIRD NEGATIVE LENS

24, 27, 43, GR11, GR21, GR22, GR31, GR32, GR33 CEMENTED DIVISION GROUP

25 FOURTH POSITIVE LENS

26 FIFTH NEGATIVE LENS

28 SIXTH POSITIVE LENS

41 FIRST NEGATIVE LENS

42 SECOND POSITIVE LENS

44 to 48 THIRD TO SEVENTH POSITIVE LENSES

50 FIRST LENS FRAME

60 SECOND LENS FRAME

100, 150 BASE

101 to 103 EXCITATION LIGHT SOURCE

111, 153, 162b TOTAL REFLECTION MIRROR

114 PERFORATED MIRROR

114a HOLE

112, 113, 115, 162a DICHROIC MIRROR

116, 116A, 116B, 416, 416A OBJECTIVE LENS

120 MICROCHIP

123a SPOT

130 BACKSCATTERED LIGHT DETECTION SYSTEM

131, 133, 135, 161, 164a, 164b LENS

132, 163a, 163 b DIAPHRAGM

134 MASK

136, 142, 167a, 167b PHOTODETECTOR

140 FLUORESCENCE DETECTION SYSTEM

141 SPECTROSCOPIC OPTICAL SYSTEM

143 IMAGE FORMING LENS

144 SORTING FIBER

151 FILTER

165a, 165b FILTER

152 COLLIMATING LENS

166a, 166 b DIFFRACTION GRATING

G11, G13, G14, G21, G23, G25, G26, G31, G33, G35, G36, G37 POSITIVE LENS

G12, G22, G24, G32, G34, G38 NEGATIVE LENS

L1 to L3 EXCITATION LIGHT

L12 BACKSCATTERED LIGHT

L14 FLUORESCENCE

L16 LIGHT

L17, L18 FORWARD SCATTERED LIGHT

1. An optical measurement device comprising:
an excitation light source that emits excitation light having a wavelength of at least 450 nanometers or less;
a lens structure that condenses the excitation light at a predetermined position;
a fluorescence detection system that detects fluorescence emitted from a particle by excitation of the particle present at the predetermined position by the excitation light; and
a scattered light detection system that detects scattered light generated by the excitation light being scattered by the particle present at the predetermined position,
wherein the lens structure includes a plurality of lenses arranged along an optical axis of the excitation light, and a lens frame that holds the plurality of lenses, and
a position of at least one of the plurality of lenses in the lens frame is determined by abutting on a lens adjacent to the lens.

2. The optical measurement device according to claim 1, wherein the scattered light detection system detects scattered light having passed through the lens structure.

3. The optical measurement device according to claim 1, wherein
the lens structure further includes at least one interval ring interposed between the plurality of lenses, and
a position of at least one of the plurality of lenses in the lens frame is determined by abutting on the interval ring interposed between the lens and a lens adjacent to the lens.

4. The optical measurement device according to claim 1, wherein
the plurality of lenses includes at least one cemented division group including a positive lens having positive refractive power and a negative lens having negative refractive power, and
the positive lens and the negative lens constituting the cemented division group are in contact with each other.

5. The optical measurement device according to claim 4, wherein the at least one cemented division group is one of the cemented division group.

6. The optical measurement device according to claim 4, wherein the at least one cemented division group is two of the cemented division groups.

7. The optical measurement device according to claim 4, wherein the at least one cemented division group is three of the cemented division groups.

8. The optical measurement device according to claim 4, wherein the positive lens constituting at least one of the at least one cemented division group has a refractive index of 1.6 or less, an Abbe number of 65 or more, and a partial dispersion ratio of 0.55 or less.

9. The optical measurement device according to claim 4, wherein the plurality of lenses further includes:
a first single lens having positive refractive power; and
a second single lens having positive refractive power, and the first single lens and the second single lens are disposed at positions sandwiching the at least one cemented division group.

10. The optical measurement device according to claim 4, wherein
the at least one cemented division group includes two or more of the cemented division groups, and
two cemented division groups adjacent to each other among the two or more cemented division groups are positioned to each other by abutting on an interval ring interposed between the two cemented division groups.

11. The optical measurement device according to claim 1, wherein the plurality of lenses is arranged along an optical axis of the excitation light in descending order of diameters in a direction perpendicular to the optical axis.

12. The optical measurement device according to claim 11, wherein the lens frame is a single member.

13. The optical measurement device according to claim 1, wherein the scattered light is backscattered light propagating along an optical path of the excitation light from the predetermined position.

14. The optical measurement device according to claim 1, wherein an adhesive is not used to fix the plurality of lenses.

15. A lens structure that condenses at a predetermined position excitation light emitted from an excitation light source that emits excitation light having a wavelength of at least 450 nanometers or less, the lens structure comprising:
a plurality of lenses arranged along an optical axis of the excitation light; and
a lens frame that holds the plurality of lenses,
wherein a position of at least one of the plurality of lenses in the lens frame is determined by abutting on a lens adjacent to the lens.
